(19) United States
(12) Patent Application Publication
(10) Pub. No.: US 2012/0297548 A1
(43) Pub. Date: Nov. 29, 2012

(54) COOKING UTENSIL

(75) Inventor: Clive Solari, Paddington (AU)

(73) Assignee: MCPHERSON'S LIMITED, Mulgrave, Victoria (AU)

(21) Appl. No.: 13/518,961

(22) PCT Filed: Dec. 24, 2010
(86) PCT No.: PCT/AU2010/001750

§ 371 Date: Jul. 26, 2012

(30) Foreign Application Priority Data
Jan. 8, 2010 (AU) 2010900067

(51) Int. Cl. A47J 43/28

(52) U.S. Cl. 7/113; 294/7; 294/106; 30/299

(57) ABSTRACT

The present invention relates, in one aspect, to a cooking utensil including a functional member configured to engage a food item and a handle member extending from the functional member for gripping the utensil and for moving the functional member. The functional member includes a blade having a pair of opposite surfaces meeting at a pair of opposite lateral edges, one of the lateral edges being sharpened to form a cutting edge and the other one of the lateral edges including prongs and at least one of the planar surfaces having one or more recesses that do not pass entirely through the blade. In a preferred form, the one or more recesses include one or more concave depressions in the at least one of the planar surfaces. The present invention relates, in another aspect, to a cooking utensil including a functional member configured to engage a food item and a handle member extending from the functional portion for gripping the utensil and for moving the functional portion wherein a length by which the handle member extends from the functional portion is adjustable. In one embodiment the cooking utensil is a spatula and in another embodiment a pair of tongs.

### FIELD OF THE INVENTION

This invention relates generally to cooking utensils and is particularly, but not exclusively, concerned with barbeque cooking utensils such as tongs and spatulas. The present invention is described herein with reference to cooking tongs and a cooking spatula that is useful for cooking and is particularly useful for cooking on a barbeque, hotplate, camp fire or with respect to any other form of cooking apparatus.

### BACKGROUND OF THE INVENTION

Conventional barbeque cooking utensils, such as tongs and spatulas, typically include a functional portion attached to a handle. In use, a user holds the handle and manipulates the functional portion of the utensil to perform some action with respect to food on a cooking surface. In the case of tongs, the functional portion typically includes a pair of elongated arms that extend in a substantially parallel direction. Each of the arms has a gripping portion at one end and are pivotally connected at an end opposite to the gripping portions to enable the arms and the gripping portions to open and close in a manner similar to a set of jaws. Portions of the arms between the gripping portions and the pivotal connection forms a handle or gripping portion. In use, a user grips the tongs via the gripping portions and closes and opens the gripping portions by respectively squeezing and releasing the arms against the action of a biasing member, which is typically in the form of a torsion spring, that is operable to bias the arms, and the gripping portions, from a closed position to an open position.

In use, a user can hold the spatula of tongs by their respective handles partially or completely above a cooking surface while using the functional portion to manipulate food on the cooking surface. As can be appreciated, when a user holds their hand partially or completely above a cooking surface, heat emanating from the cooking surface will reach the user's hand holding the tongs and may cause some discomfort to the user. To alleviate this problem, some tongs are provided with longer arms so as to enable a user to hold the tongs at a position located further from the gripping portions so that the user's hand does not have to be positioned partially or completely above the cooking surface. However, a drawback with such tongs is that by having relatively long arms they can be more unwieldy to use in situations where long arms are not required to avoid heat from a cooking surface causing discomfort to a user and cause a problem with storing as such tongs take up more space than tongs with shorter length arm.

Conventional cooking spatulas have a functional portion in the form of a broad, flat blade attached to a handle for gripping the spatula. In use, a user holds the spatula by the handle to control the functional portion for cutting, mixing, spreading or lifting material on a cooking surface.

Cooking spatulas are often used to lift food items off a cooking surface and/or to place food items on a cooking surface. This is done by sliding or otherwise placing the flat blade of the spatula under the food item so that the food item is supported on an upper surface of the flat blade. A problem with existing spatulas is that when a food item is to be removed from the upper surface of the blade to be placed on the cooking surface for cooking or onto some other surface after cooking the food item may be adhered to the upper surface of the blade and may not slide easily off the blade.

Another problem with existing spatulas is that when a user uses the spatula their hand holding the handle is usually partially or completely above the cooking surface and is subjected to heat rising from the cooking surface. Some existing spatulas are provided with longer handles so that a user can hold the spatula a further distance away from the functional portion so that in use a user's hand does not have to be partially or completely above the cooking surface. A problem with spatulas having longer length handles is that they are more unwieldy in use than spatulas having shorter length handles which may be undesirable when a user does not require the longer length handle to avoid being subjected to excessive amounts of heat rising from a cooking surface. Furthermore, spatulas having longer length handles take up more space and are difficult to store when not in use.

Accordingly, the present invention seeks to ameliorate the problems set out above with respect to cooking utensils by providing a utensil having a functional portion and a handle or gripping portion that enables a user to grip the utensil a relatively long distance away from the functional portion by a distance sufficient to avoid or substantially ameliorate the problem of the user's hand being subjected to heat rising from a cooking surface. Forms of the invention may achieve the above advantage by enabling the user to hold the utensil with the functional portion over the cooking surface whilst their hand is not above or is not substantially above the cooking surface. This form of the invention is particularly advantageous where the user is cooking on a relatively large cooking surface and access to distant parts of the cooking surface is required.

The utensil of the invention is also advantageous in that it is also useful for cooking on a relatively small cooking surface or where access to distant parts of a cooking surface is not required or when the amount of heat rising from the cooking surface is not sufficient to cause discomfort to a user holding their hand above the cooking surface. In such circumstances, the invention provides a utensil that is not unwieldy and is relatively easy to manipulate and control. A need also exists for a cooking utensil having the above advantages while also taking up a relatively small amount of space so as to be relatively easy to store when not in use.

The present invention seeks to ameliorate the problems set out above with respect to cooking utensils by providing a cooking utensil, such as a spatula but not limited to a spatula, that can lift food items off a cooking surface and/or to place food items on a cooking surface and reducing the extent to which the food item adheres, or becomes stuck, to the cooking utensil.

A reference herein to a patent document or other matter which is given as prior art is not to be taken as an admission that that document or matter was, in Australia, known or that the information it contains was part of the common general knowledge as at the priority date of any of the claims.

### SUMMARY OF THE INVENTION

In one aspect, the present invention provides a cooking utensil including:
a functional member configured to engage a food item,
a handle member extending from the functional member for gripping the utensil and for moving the functional member,
the functional member including a blade having a pair of opposite surfaces meeting at a pair of opposite lateral edges, one of the lateral edges being sharpened to form a cutting edge and the other one of the lateral edges including prongs and at least one of the planar surfaces having one or more recesses that do not pass entirely through the blade.

In an embodiment, the one or more recesses include one or more concave depressions in the at least one of the planar surfaces.

In another embodiment, the lateral edge including the prongs also includes a curved cutting edge.

In yet another embodiment, the blade has a proximal end and a distal end, the functional member further including a neck portion extending from the proximal end of the blade to the handle member, wherein the blade further includes a tab extending from the proximal end and overlapping the neck portion to define the V-shaped recess between the tab and the neck portion.

In still yet another embodiment, the handle member includes a proximal end and an opposite distal end, the distal end being immediately adjacent the functional member, a bottle opener device being mounted within an opening in the handle member adjacent the proximal end of the handle member.

In an embodiment, the centre of gravity of the functional member and the handle member is located so that when the utensil is rested on a flat surface the flat blade rests flat on the surface and the handle member is elevated above the surface.

In a preferred form, the utensil is a cooking spatula.

In an embodiment, a length by which the handle member extends from the functional member is adjustable.

Preferably, the handle member includes first and second elongated members that are telescopically slidable relative to each other so as to adjust the overall length of the handle member.

In another preferred form, the first and second elongated members are fixable in a plurality of positions relative to each other to provide a variety of overall lengths of the handle member.

In another aspect, the invention provides a cooking utensil including:
a functional member configured to engage a food item,
a handle member extending from the functional portion for gripping the utensil and for moving the functional portion,
wherein a length by which the handle member extends from the functional portion is adjustable.

In an embodiment, the handle member includes first and second elongated members that are telescopically slidable relative to each other so as to adjust the overall length of the handle member.

In a preferred form, the first and second elongated members are fixable in a plurality of positions relative to each other to provide a variety of overall lengths of the handle member.

In a further preferred form, one end of the first elongated member is connected to the functional member and an opposite end of the first elongated member includes a plurality of spaced apart apertures, one end of the second elongated member includes a locking member which is receivable within one of the plurality of apertures of the first elongated member to fix the first and second elongated members in a respective one of the plurality of positions relative to each other.

In yet a further preferred form, the locking member has a locking position and an unlocking position, in the locking position the locking member is positioned within one of the plurality of apertures of the first elongated member to fix the fix the first and second elongated members in position relative to each other and in the unlocking position the locking member is positioned outside each of the plurality of apertures of the first elongated member to enable the first and second elongated members to move relative to each other.

In a preferred form, the locking member is a biased towards the locking position and is manually movable from the locking position to the unlocking position to enable adjustment of the overall length of the handle member.

In another preferred form, the second elongated member includes an opening that slidably receives the end of the first elongated member including the plurality of spaced apart apertures.

In an embodiment, the utensil includes two of the handle members and two of the functional members, wherein the handle members are pivotally connected to each other to enable the handle members and the functional members to open and close like a set of jaws. In a preferred form, the utensil is a set of cooking tongs. In a further preferred form, the functional member includes a gripping surface for gripping a food item.

In another embodiment, the functional member has a proximal end and a distal end, the functional member includes a flat blade at the distal end and a neck portion at the proximal end connected to the handle member, the flat blade member has a pair of opposite substantially planar surfaces extending from the neck portion to a pair of opposite lateral edges and a transverse distal edge extending between the lateral edges, at least one of the planar surfaces including one or more recesses. Preferably, the one or more recesses do not pass entirely through the blade. In an embodiment, the one or more recesses include one or more concave depressions in the at least one of the planar surfaces.

Preferably, one of the lateral edges is sharpened to form a blade, the other one of the lateral edges includes a set of prongs and a curved cutting edge.

In another preferred form, the functional member further includes a tab extending in a direction from the distal end towards the proximal end and overlaps the neck portion to define a V-shaped recess for hanging the utensil when not in use. Preferably, the utensil is a cooking spatula. In a preferred form, the handle member includes a bottle opener device.

### BRIEF DESCRIPTION OF THE DRAWINGS

FIG. 1 illustrates a perspective view of a cooking spatula in accordance with an embodiment of the invention, the spatula including a functional member in the form of a flat blade and an adjustable length handle member extending from the functional portion wherein the handle member is in its shortest length setting.

FIG. 2 illustrates a plan view of the cooking spatula of FIG. 1.

FIG. 3 illustrates a side view of the cooking spatula of FIG. 1.

FIG. 4 illustrates an end view of a cross section of the handle member of the cooking spatula of FIG. 1 taken along the section line A-A shown in FIG. 2.

FIG. 5 illustrates an exploded perspective view of the cooking spatula of FIG. 1.

FIG. 6 illustrates a perspective view of the cooking spatula of FIG. 1 with the adjustable length handle member in its longest length setting.

FIG. 7 illustrates a perspective view of a cooking spatula in accordance with another embodiment of the invention including a functional member in the form of a flat blade and a handle member extending from the functional portion.

FIG. 8 illustrates a perspective view of the cooking spatula of FIG. 7 wherein a gripping member of the handle member is partially cut away in a longitudinal direction.

FIG. 9 illustrates a plan view of the cooking spatula of FIG. 7.

FIG. 10 illustrates a perspective view of a set of cooking tongs in accordance with an embodiment of the invention, the tongs including two functional portions in the form of a pair of gripping members arranged in opposing relation to form a set of jaws and two adjustable length handle members extending from the functional portions wherein the handle members are in their shortest length setting.

FIG. 11 illustrates a plan view of the tongs of FIG. 10.

FIG. 12 illustrates a side view of the tongs of FIG. 10.

FIG. 13 illustrates an end view of a cross section of the handle members of the tongs of FIG. 10 taken along the section line B-B shown in FIG. 11.

FIG. 14 illustrates an exploded perspective view of the tongs of FIG. 10.

FIG. 15 illustrates a perspective view of the tongs of FIG. 10 with each of the adjustable length handle members in their longest length setting.

### DETAILED DESCRIPTION

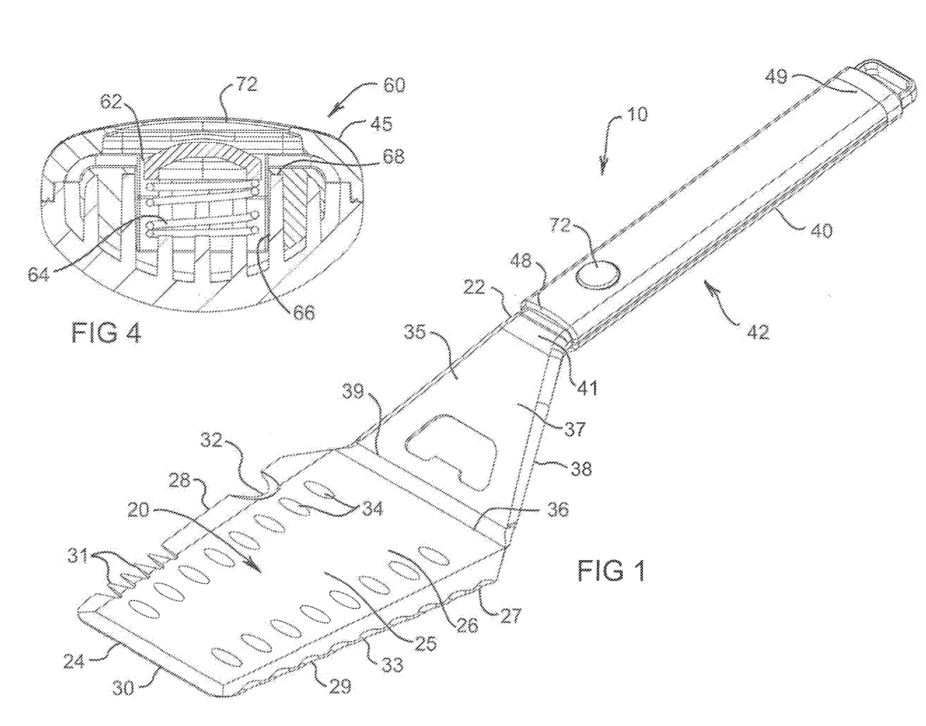

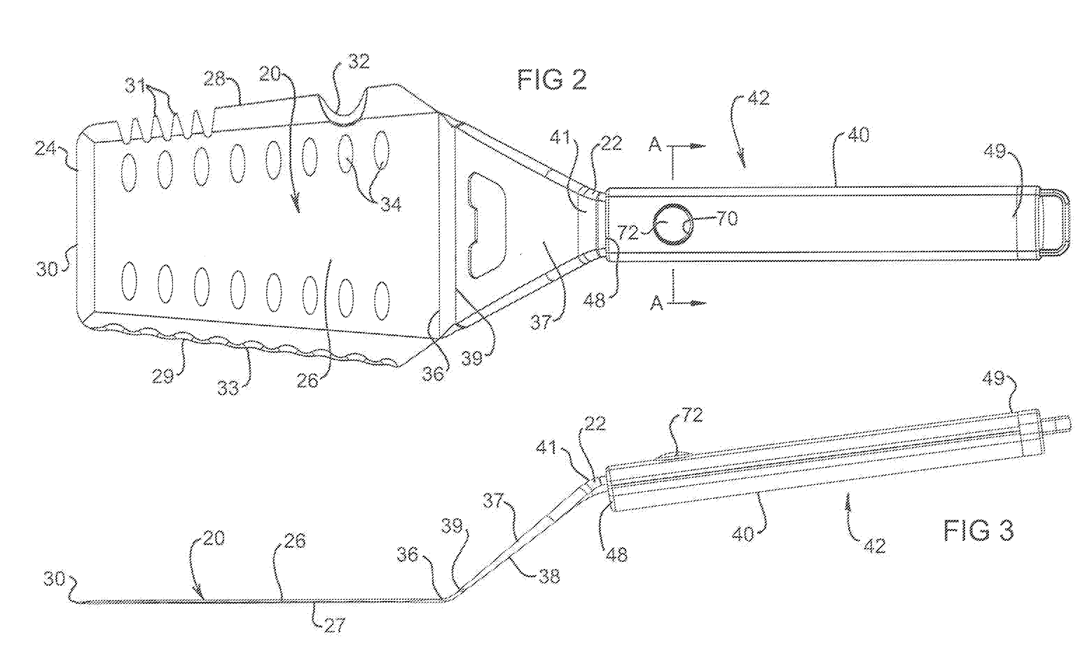

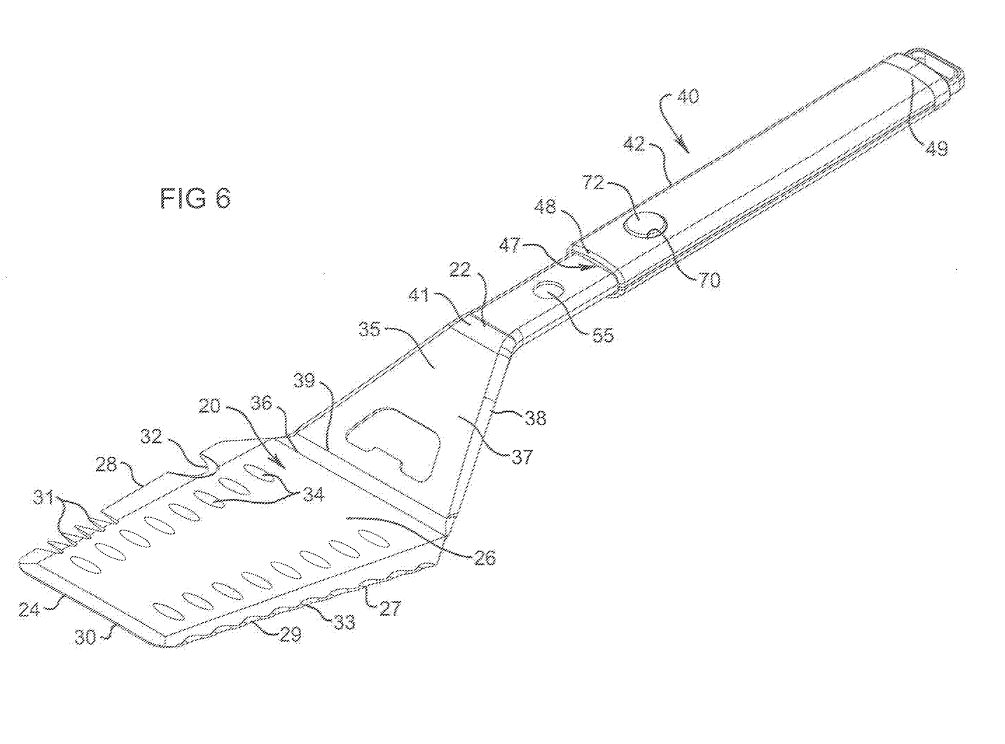

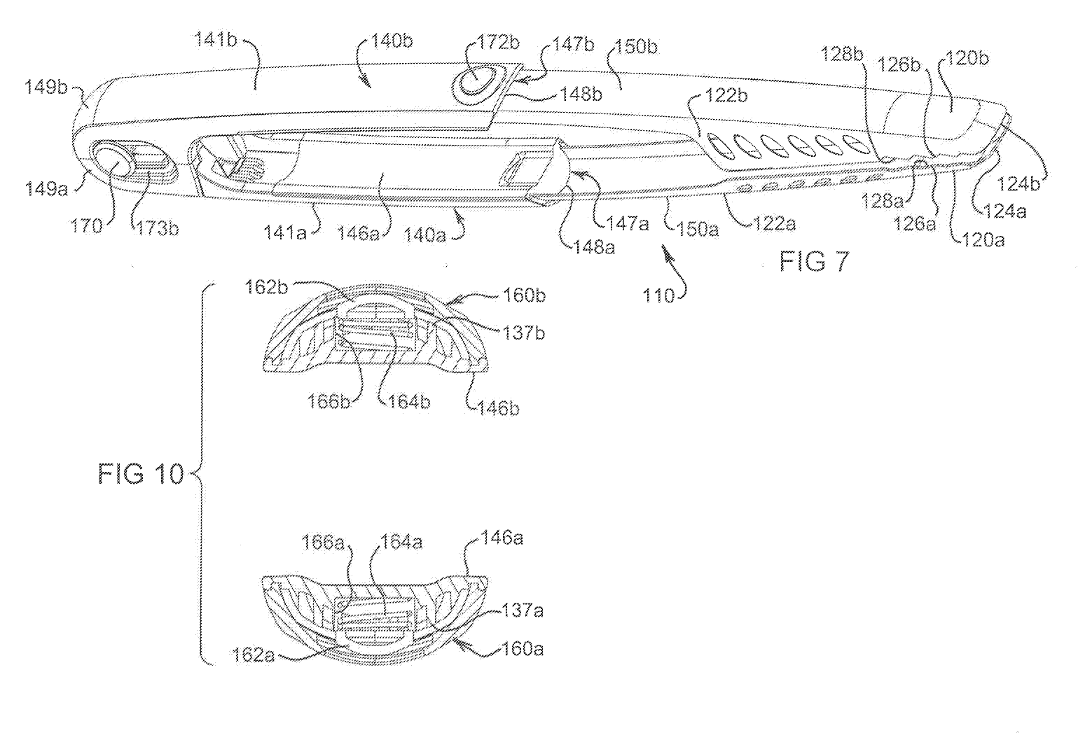

Referring to the Figures, there is shown two embodiments of a cooking utensil 10, 10a, 110 in accordance with preferred forms of the invention. The utensils 10, 10a illustrated in FIGS. 1 to 9 are cooking spatulas whereas the utensil 110 shown in FIGS. 7 to 12 is a pair of cooking tongs. The cooking utensils 10, 110 of FIGS. 1 to 6 and 10 to 15 includes a functional member configured for engaging food items on a cooking surface and a handle member extending from the functional member wherein the length by which the handle member extends from the functional portion is adjustable.

Referring to FIGS. 1 to 6, the spatula 10 includes a functional member 20 and a handle member 40. The functional member 20 includes a proximal end 22 and a distal end 24. The distal end 24 includes a flat blade 25 having a pair of opposite substantially planar top and bottom surfaces 26, 27. The top and bottom surfaces 26, 27 meet at a pair of opposite lateral edges 28, 29 which extend either in a substantially parallel direction or in a slightly canted or inclined manner such that the directions in which the opposite lateral edges 28, 29 extend would intersect. The top and bottom surfaces 26, 27 also meet at a transverse edge 30 which extends between and to each of the opposite lateral edges 28, 29. The transverse edge 30 of the flat blade 25 provides the most distal component of the flat blade 25 at the distal end 24 of the functional member 20.

One of the opposite lateral edges 28 includes a set of transversely extending prongs 31 which are useful for piercing food items, such as sausages, on a cooking surface. The same opposite lateral edge 28 also includes a curved cutting edge 32 which is useful for cutting the connecting portions that connect pairs of sausages to each other. The opposite lateral edge 29 is sharpened to thereby provide a sharpened cutting edge 33. The opposite lateral edge 29 and the sharpened cutting edge 33 thereof illustrated in FIGS. 1 to 6 are substantially straight, however, it is to be appreciated that the lateral edge 29 and the sharpened cutting edge 33 thereof may be curved. The curve of the lateral edge 29 and the sharpened cutting edge 33 is preferably a convex curve. In the embodiment illustrated in FIGS. 1 to 6 the cutting edge 33 is serrated but it could be a continuously straight cutting edge. The top planar surface 26 also includes a set of recesses 34. In the illustrated embodiment of the spatula 10 the recesses 34 are in the form of scallops or indentations that do not pass entirely through the blade 25 of the spatula 10. Each of the recesses 34 is formed by providing a concave surface which extends below the level of the top planar surface 26. An advantage of the recesses 34 is that they may prevent or at least reduce the likelihood of food becoming stuck to the top planar surface 26 of the blade 25 when the spatula 10 is used to lift a food item off a cooking surface. Accordingly, the scallops 34 enable a food item to easily slide off the top surface 26 of the flat blade 25 and not become stuck thereto.

The flat blade 25 is integrally formed with a neck portion 35 which extends from the top and bottom planar surfaces 26, 27 at a proximal end 36 of the flat blade 25 opposite the transverse edge 30. The neck portion 35 includes a pair of opposite top and bottom planar surfaces 37, 38 which respectively extend continuously from the top and bottom planar surfaces 26, 27 of the flat blade 25. The top and bottom surfaces 37, 38 of the neck portion 35 have a canted or sloped profile and extend from a substantially wider base 39 which is integrally formed with, and immediately adjacent to, the proximal end 36 of the flat blade 25. The top and bottom surfaces 37, 38 of the neck portion 35 extend from the wider base 39 to a narrower top 41 which is connected to the handle member 40. The narrower top 41 of the neck portion 35 forms the proximal end 22 of the functional member 20.

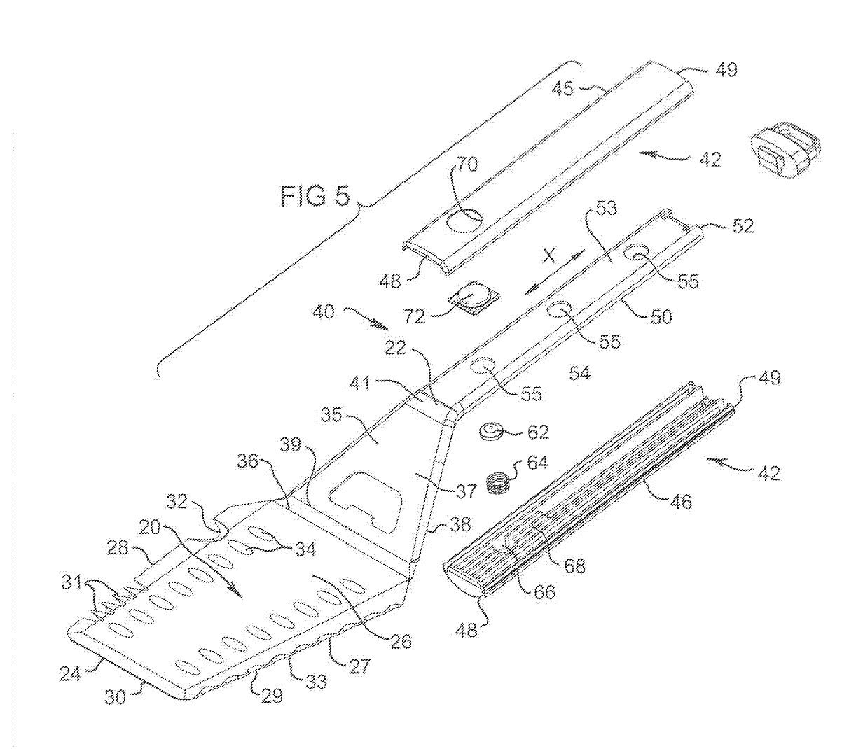

The components and operation of the handle member 40 of the spatula 10 will now be described with reference to FIGS. 1 to 6. Referring to FIG. 5, the handle member 40 includes a first elongated member 50 and a second elongated member 41 wherein the first and second elongated members 50, 41 are telescopically slidable relative to each other.

The first elongated member 50 is a substantially straight elongated member extending from, and integrally formed with, the proximal end 22 of the functional member 20. The first elongated member 50 extends from the proximal end 22 of the functional member 20 to a tip 52 at a proximal end of the first elongated member 50. The first elongated member 50 has a pair of opposite top and bottom surfaces 53, 54 which extend from the proximal end 22 of the functional member 20 to the tip 52 of the first elongated member 50. The top and bottom planar surfaces 53, 54 are substantially planar. The first elongated member 50 includes a plurality of openings 55 which extend between the top and bottom surfaces 53, 54 to provide passages from the top surface 53 to the bottom surface 54.

The second elongated member 41 includes a top shell portion 45 and a bottom shell portion 46. The top and bottom shell portions 45, 46 are preferably formed out of a polymer material but could also be formed out of a metallic material. The top and bottom shell portions 45, 46 are configured to be connected to each other along lateral edges thereof to form a second elongated member 41 including a longitudinal opening 47 therewithin. The opening 47 is configured to receive the first elongated member 50. Accordingly, the first elongated member 50 is configured to be slidable within the opening 47 of the second elongated member 41 in a telescopically slidable manner. The top and bottom shell portions 45, 46 forming the second elongated member 41 have a distal end 48 and a proximal end 49. The distal end 48 is located closer than the proximal end 49 to the functional member 20. In use, the second elongated member 41 is configured to slide relative to the first elongated member 50 so that the distance between the functional member 20 and the proximal end 49 of the second elongated member 41, and thereby the overall length of the handle member 40, can be increased or reduced to thereby provide a handle member 40 having an adjustable overall length. Thus, the distance between the proximal end 22 of the functional member 20 and the proximal end 49 of the second elongated member 41 can be increased or reduced.

The telescopically slidable first second elongated members 50, 41 are fixable in a plurality of positions relative to each other to provide a plurality of overall lengths of the handle member 40 in a manner as will be described herein below. The handle member 40 includes a locking mechanism 60. A cross section of the locking mechanism 60 is shown in FIG. 4 and the components of the locking mechanism 60 are shown in the exploded view of FIG. 5. The locking mechanism 60 includes a locking member, which in the embodiment illustrated in the figures is in the form of a cylindrical disk 62 mounted on a resilient compression spring 64 wherein the compression spring 64 is mounted within a recess 66 within a facing surface 68 of the bottom shell portion 46 of the second elongated member 41. The disk 62 is also partially received within the recess 66.

As can be appreciated, the disk 62 is configured to be selectively received within one of the openings 55 of the first elongated member 50 at a time. As the second elongated member 41 is slid over the first elongated member 50 in a direction extending between the proximal end 22 of the functional member 20 and the tip 52 of the first elongated member 50 illustrated by the arrow X the locking mechanism 60 comprising the recess 66, the spring 64 and the disk 62 meet with any one of the openings 55 along the length of the first elongated member 50. When the locking mechanism 60 meets and engages one of the openings 55 the disk 62 is received within the opening 55. When the disk 62 is received within a respective one of the openings 55 the disk is also partially within the recess 66 and thereby engages the respective one of the openings 55 and the recess 66 simultaneously to releasably lock or fix the recess 66 and the second elongated member 41 relative to the respective one of the openings 55 and the first elongated member 50. Accordingly, for each of the openings 55 within the first elongated member 50 the second elongated member 41 is selectively fixable to the first elongated member 50 at a respective relative position in the direction illustrated by the arrow X to provide a respective overall length of the handle member 40.

The top shell portion 45 of the second elongated member 41 includes a button hole 70 receiving a button 72 therethrough. The button 72 is mounted within the buttonhole 70 and can be manually depressed by a user to cause the disk 62 to be pushed out of a respective one of the openings 55 to enable the second elongated member 41 to be slid relative to the first elongated member 50 until the locking mechanism 60 reaches and engages another one of the openings 55 of the first elongated member 50 to provide a different overall length of the handle member 40. Thus, the button 72 is operable for releasing the locking mechanism 60 and enabling the second elongated member to be slid relative to the first elongated member 50 in the direction of the arrow X. When the locking mechanism 60 reaches another one of the openings 55 the action of the spring 64 biases the disk 62 into that opening 55 to thereby engage that opening 55 and fix the first and second elongated members 50, 41 relative to each other.

The spatula 10 in accordance with the invention is advantageous in that it includes a functional member 20 in the form of a flat blade 25 including top and bottom planar surfaces 26, 27 for lifting a food item, a cutting edge 33 for cutting a food item, prongs 31 for piercing a food item and a curved cutting edge 32 for cutting food items on a cooking surface, and in particular for separating sausages, as well as a handle member 40 which has an overall length which is extendable. As such, a user holding the handle member 40 to manipulate the functional member 20 over a cooking surface can extend the length by which the handle member 40 extends from the functional portion 20 to ameliorate the extent to which the user's hand needs to be placed above the cooking surface and thereby ameliorates the extent to which the user's hand is affected by heat rising from the cooking surface when using the spatula 10. Furthermore, the locking mechanism 60 provides a convenient means for locking the handle member 40 in a variety of overall lengths and for unlocking the handle member 40 to enable adjustment of the overall length thereof.

Referring to FIGS. 7 to 9, there is shown the spatula 10a includes a functional member 20a and a handle member 40a. The functional member 20a includes a proximal end 22a and a distal end 24a. The distal end 24a includes a flat blade 25a having a pair of opposite substantially planar top and bottom surfaces 26a, 27a. The top and bottom surfaces 26a, 27a meet at a pair of opposite lateral edges 28a, 29a that extend either in a substantially parallel direction or in a slightly canted or inclined manner such that the directions in which the opposite lateral edges 28a, 29a extend would intersect. The top and bottom surfaces 26a, 27a also meet at a transverse edge 30a which extends between and to each of the opposite lateral edges 28a, 29a. The transverse edge 30a of the flat blade 25a provides the most distal component of the flat blade 25a at the distal end 24a of the functional member 20a.

Similar to the embodiment illustrated in FIGS. 1 to 6, the spatula 10a of FIGS. 7 to 9 includes a set of transversely extending prongs 31a along one of the opposite lateral edges 28a. The prongs 31a are useful for piercing food items, such as sausages, on a cooking surface. The same opposite lateral edge 28a also includes a curved cutting edge 32a. The other opposite lateral edge 29a is sharpened to thereby provide a sharpened cutting edge 33a. The top planar surface 26a also includes a set of scallops or recesses 34a. As mentioned above, and advantages of the scallops or recesses 34a is that they may reduce the extent of friction between a food item being lifted on the top planar surface 26a.

The flat blade 25a is integrally formed with the neck portion 35a extending from a proximal end 36a of the flat blade 25a opposite the transverse edge 30a. The neck portion 35a includes a pair of opposite top and bottom planar surfaces 37a, 38a which respectively extend continuously from the top and bottom planar surfaces 26a, 27a of the flat blade 25a. The top and bottom surfaces 37a, 38a of the neck portion 35a have canted or sloped profile and extend from a substantially wider base 39a integrally formed with the proximal end 36a of the flat blade 25a. The top and bottom surfaces 37a, 38a of the neck portion 35a extend from the wider base 39a to a narrower top 41a which is connected to the handle member 40a. The narrower top 41 a of the neck portion 35a forms the proximal end 22a of the functional member 20a.

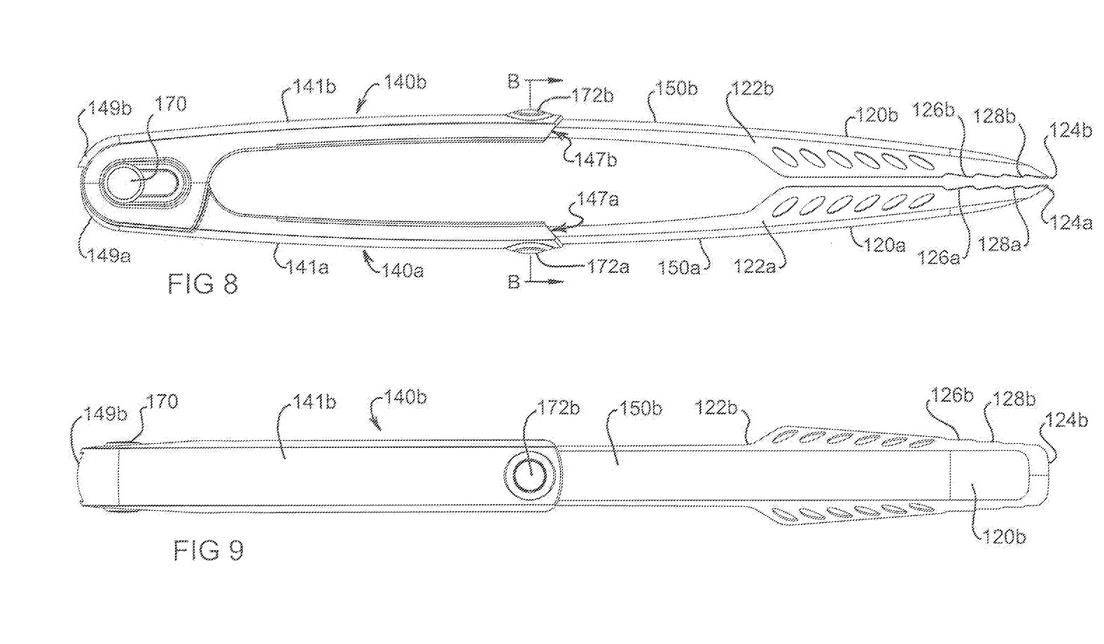

Referring to FIGS. 7 to 9, the handle 40a includes a grip member 42a formed around and mated to a tang 50a which extends from the top 41 a of the neck portion 35a. Accordingly, the tang 50a is positioned as shown in FIG. 8 which illustrates a section view of the moulded grip member 42a, through the centre of the grip member 42a from a distal end 48a towards a proximal end 49a of the grip member 42a. The grip member 42a includes an opening 51a extending between opposite top and bottom surfaces 52a, 53a of the grip member 42a. Fixed within the opening 51a is a bottle opener member 54a that is suitable for use to remove crown caps from beverage bottles such as beer bottles and wine bottles and the like. The bottle opener member 54a is located nearer the top surface 52a than the bottom surface 53a of the grip member 42a. Thus, a bottle crown cap can be inserted into the opening 51a from the top and removed from the bottle by the bottle opener member 54a. However, the bottom surface 53a of the grip member 42a is formed to slope upwardly towards the bottle opener member 54a, as shown in FIG. 8, so that the bottle opener member 54a is functional to enable a bottle crown lid inserted into the opening 51 a from the grip member 42a and removed from the bottle by the bottom of the bottle opener member 54a.

Referring to FIGS. 10 to 15, there is shown another embodiment of cooking utensil in accordance with the invention in the form of a pair of cooking tongs 110. The cooking tongs 110 include a pair of functional members 120a, 120b and a pair of handle members 140a, 140b. The functional members 120a, 120b each include a proximal end 122a, 122b and a distal end 124a, 124b. The distal end 124a, 124b of each of the functional members 120a, 120b includes a jaw member 126a, 126b. Each of the jaw members 126a, 126b includes a set of serrated teeth 128a, 128b. The jaw members 126a, 126b and the respective teeth 128a, 128b thereof are arranged in opposing relation and are configured to grip a food item therebetween in a manner which will be described in more detail below.

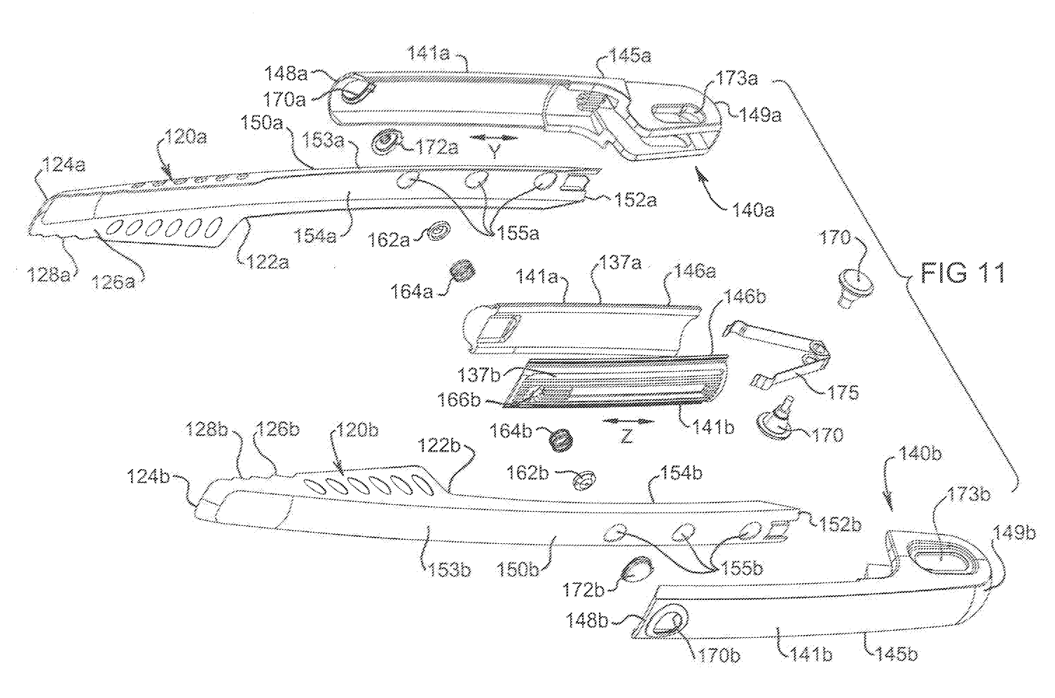

The components and operation of the handle members 140a, 140b of the tongs 110 will now be described with reference to FIGS. 7 to 12. Referring to FIG. 11, the handle members 140a, 140b each include a first elongated member 150a, 150b and a second elongated member 141a, 141b wherein the first and second elongated members 150a, 150b, 141a, 141b are telescopically slidable relative to each other.

The proximal end 122a, 122b of each of the functional members 120a, 120b is integrally connected with a respective one of the handle members 140a, 140b. In particular, the proximal end 122a, 122b of each of the functional members 120a, 120b is integrally formed with a respective first elongated member 150a, 150b of each of the handle members 140a, 140b. The first elongated members 150a, 150b are each generally longitudinal members extending from the proximal end 122a, 122b of each of the functional members 120a, 120b to a respective tip 152a, 152b. Each of the first elongated members 150a, 150b includes a pair of opposite top and bottom surfaces 153a, 153b, 154a, 154b extending from the functional members 120a, 120b to the tips, 152a, 152b. Each of the bottom surfaces 154a, 154b of the first elongated members 150a, 150b face each other. A set of three or more or less openings 155a, 155b is provided in each of the first elongated members 150a, 150b and extends from each of the top surfaces 153a, 153b to the bottom surfaces 154a, 154b to provide a set of apertures therethrough.

Each of the handle members 40a, 40b also includes a second elongated member 141a, 141b that is telescopically relative to a respective one of the first elongated members 150a, 150b to provide a variety of overall lengths of each of the handle members 150a, 150b. Each of the second elongated members 141a, 141b includes a respective top shell portion 145a, 145b and a respective bottom shell portion 146a, 146b. Each of the top and bottom shell portions 145a, 145b, 146a, 146b is configured to be connected together along lateral side edges thereof to form a respective opening 147a, 147b therethrough, as shown in FIGS. 7, 8 and 12, to slidably receive the first elongated member 150a, 150b therewithin. The second elongated members 141a, 141b each have a respective distal end 148a, 148b and a proximal end 149a, 149b. The distal end 148a, 148b of each of the second handle members 141a, 141b is arranged to be located towards the functional members 120a, 120b relative to the proximal ends 149a, 149b. Thus, the first elongated member 150a, 150b is telescopically slidable within and relative to the second elongated members 141a, 141b to enable the overall length of the handle members 140a, 140b between the functional members 120a, 120b and the proximal end 149a, 149b of each of the second handle members 141a, 141b to be increased or decreased as required.

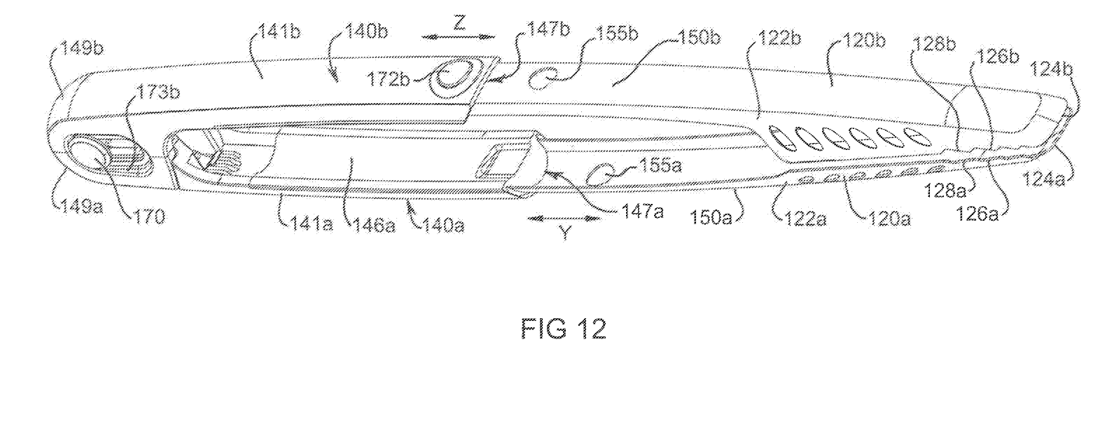

As best shown in FIG. 13, each of the handle members 140a, 140b includes the respective locking mechanism 160a, 160b having a respective recess 166a, 166b in a top surface 137a, 137b of each of the bottom shell portions 146a, 146b, a spring 164a, 164b and a disk 162a, 162b fitted within each of the recesses 166a, 166b. As can be appreciated, each of the disks 162a, 162b are configured to be selectively received within one of the openings 155a, 155b of one of the first elongated members 150a, 150b at a time. As the second elongated members 141a, 141b are slid over the first elongated members 150a, 150b in a direction extending between the proximal ends 122a, 122b of the functional members 120, 120b and the tip 152a, 152b of the first elongated members 150a, 150b illustrated by the arrows Y, Z in FIGS. 11 and 12 the locking mechanisms 160a, 160b comprising the recesses 166a, 166b, the springs 164a, 164b and the disks 162a, 162b meet with any one of the openings 155a, 155b along the lengths of the first elongated members 150a, 150b. When the locking mechanisms 160a, 160b meet and engage one of the openings 155a, 155b the disks 162a, 162b are received within the openings 155a, 155b. When the disks 162a, 162b are received within a respective one of the openings 155a, 155b the disks are also partially within a respective one of the recesses 166a, 166b and thereby engage the respective one of the openings 155a, 155b and the recesses 166a, 166b simultaneously to releasably lock or fix the recesses 166a, 166b and the second elongated member 141a, 141b relative to the respective one of the openings 155a, 155b and the first elongated members 150a, 150b. Accordingly, for each of the openings 155a, 155b within the first elongated members 150a, 150b the second elongated members 141a, 141b are selectively fixable to the first elongated members 150a, 150b at a respective relative position in the direction illustrated by the arrows Y, Z to provide a respective overall length of the handle members 140a, 140b.

Each of the locking mechanisms 160a, 160b also includes a buttonhole 170a, 170b within each of the second elongated members 141a, 141b into which is positioned a respective button 172a, 172b which is manually operable by a user to selectively depress the disks 162a, 162b against the biasing force of the springs 164a, 164b out of a respective one of the openings 155a, 155b. Depressing the disks 162a, 162b out of a respective one of the openings 155a, 155b facilitates telescopic sliding and adjustment of the overall length of the first elongated members 150a, 150b and the second elongated members 141a, 141b and the handle members 140a, 140b until reaching a desired length. At the desired length the buttons 172a, 172b are released and the biasing action of the spring 164a, 164b biases a respective disk 162a, 162d into a respective one of the openings 155a, 155b to lock the handle members 140a, 140b at the desired overall length.

The proximal ends 149a, 149b of each of the second elongated members 141a, 141b is pivotally connected to each other by a pin member 170 which extends transversely through a respective transverse opening 173a, 173b of each of the second elongated members 141a, 141b to enable the handle members 141a, 141b and the functional members 120a, 120b to pivot relative to each other so as to open and close relative to each other in a jaw like fashion to selectively grip or release a food item from between the functional members 120a, 120b. A torsion spring or other like biasing member 175 is positioned about the pin 170 and is configured to bias the handle members 140a, 140b and the functional members 120a, 120b to an open resting position such that a user must compress the handle members 140a, 140b and the functional members 120a, 120b together to grip a food item therebetween.

As will be appreciated, the tongs 110 are advantageous in that they provide a pair of handle members 140a, 140b which are adjustable in overall length to enable a user to grip the tongs 110 and manipulate the functional members 120a, 120b, such as by opening and closing the jaw members 126a, 126b, to grip or release a food item over a cooking surface while ameliorating the extent to which the user's hand must be placed above the cooking surface and affected by heat rising therefrom such as by extending the length of the handle members 140a, 140b. Furthermore, the locking mechanism 160a, 160b of each of the handle members 140a, 140b of the tongs 110 provide a relatively convenient means for locking and releasing the first elongated members 150a, 150b from the second elongated members 141a, 141b to thereby adjust and lock the handle members 140a, 140b into a variety of overall lengths. By enabling the handle members 140a, 140b to be reduced in length enables them to be conveniently stored where space is limited or enables the tongs 110 to be used in circumstances where a relatively long length of the handle member 140a, 140b is not necessary and is unnecessarily cumbersome.

The claims defining the invention are as follows:

1. A cooking utensil including:
a functional member configured to engage a food item,
a handle member extending from the functional member for gripping the utensil and for moving the functional member,
the functional member including a blade having a pair of opposite surfaces meeting at a pair of opposite lateral edges, one of the lateral edges being sharpened to form a cutting edge and the other one of the lateral edges including prongs and at least one of the planar surfaces having one or more recesses that do not pass entirely through the blade.

2. The cooking utensil of claim 1, wherein the one or more recesses include one or more concave depressions in the at least one of the planar surfaces.

3. The cooking utensil of any one of the preceding claims, wherein the one of the lateral edges including the prongs also includes a curved cutting edge.

4. The cooking utensil of any one of the preceding claims, wherein the blade has a proximal end and a distal end, the functional member further including a neck portion extending from the proximal end of the blade to the handle member, wherein the blade further includes a tab extending from the proximal end and overlapping the neck portion to define the V-shaped recess between the tab and the neck portion.

5. The cooking utensil of any one of the preceding claims, wherein the handle member includes a proximal end and an opposite distal end, the distal end being immediately adjacent the functional member, a bottle opener device being mounted within an opening in the handle member adjacent the proximal end of the handle member.

6. The cooking utensil of any one of the preceding claims, wherein the centre of gravity of the functional member and the handle member is located so that when the utensil is rested on a flat surface the blade rests flat on the surface and the handle member is elevated above the surface.

7. The cooking utensil of any one of the preceding claims, wherein the utensil is a cooking spatula.

8. The cooking utensil of any one of the preceding claims, wherein a length by which the handle member extends from the functional member is adjustable.

9. The cooking utensil of claim 8, wherein the handle member includes first and second elongated members that are telescopically slidable relative to each other so as to adjust the overall length of the handle member.

10. The cooking utensil of claim 9, wherein the first and second elongated members are fixable in a plurality of positions relative to each other to provide a variety of overall lengths of the handle member.

11. A cooking utensil including:
a functional member configured to engage a food item,
a handle member extending from the functional portion for gripping the utensil and for moving the functional portion,
wherein a length by which the handle member extends from the functional portion is adjustable.

12. The cooking utensil of claim 11, wherein the handle member includes first and second elongated members that are telescopically slidable relative to each other so as to adjust the overall length of the handle member.

13. The cooking utensil of claim 12, wherein the first and second elongated members are fixable in a plurality of positions relative to each other to provide a variety of overall lengths of the handle member.

14. The cooking utensil of claim 13, wherein one end of the first elongated member is connected to the functional member and an opposite end of the first elongated member includes a plurality of spaced apart apertures, one end of the second elongated member includes a locking member which is receivable within one of the plurality of apertures of the first elongated member to fix the first and second elongated members in a respective one of the plurality of positions relative to each other.

15. The cooking utensil of claim 14, wherein the locking member has a locking position and an unlocking position, in the locking position the locking member is positioned within one of the plurality of apertures of the first elongated member to fix the fix the first and second elongated members in position relative to each other and in the unlocking position the locking member is positioned outside each of the plurality of apertures of the first elongated member to enable the first and second elongated members to move relative to each other.

16. The cooking utensil of claim 15, wherein the locking member is a biased towards the locking position and is manually movable from the locking position to the unlocking position to enable adjustment of the overall length of the handle member.

17. The cooking utensil of any one of claims 14 to 16, wherein the second elongated member includes an opening that slidably receives the end of the first elongated member including the plurality of spaced apart apertures.

18. The cooking utensil of any one of claims 11 to 17, wherein the utensil includes two of the handle members and two of the functional members, wherein the handle members are pivotally connected to each other to enable the handle members and the functional members to open and close like a set of jaws.

19. The cooking utensil of any one of claims 11 to 18, wherein the utensil is a set of cooking tongs.

20. The cooking utensil of any one of claims 11 to 19, wherein the functional member includes a gripping surface for gripping a food item.

21. The cooking utensil of any one claims 11 to 18, wherein the functional member has a proximal end and a distal end, the functional member includes a flat blade at the distal end and a neck portion at the proximal end connected to the handle member, the flat blade has a pair of opposite substantially planar surfaces extending from the neck portion and meeting at a pair of opposite lateral edges and at a transverse distal edge extending between the lateral edges, at least one of the planar surfaces having one or more scallops.

22. The cooking utensil of claim 21, wherein one of the lateral edges is sharpened to form a cutting edge and the other one of the lateral edges includes prongs and a curved cutting edge.

23. The cooking utensil of claim 21 or 22, wherein the flat blade has a proximal end and a distal end, the neck portion extending from the proximal end of the flat blade to the handle member, wherein the flat blade further includes a tab extending from the proximal end and overlapping the neck portion to define the V-shaped recess between the tab and the neck portion.

24. The cooking utensil of any one of claims 21 to 23, wherein the utensil is a cooking spatula.

25. The cooking utensil of any one of claims 11 to 24, wherein the handle member includes a bottle opener device.
